(19) United States
(12) Patent Application Publication
(10) Pub. No.: US 2025/0298637 A1
(43) Pub. Date: Sep. 25, 2025

(54) COMPUTER-BASED SYSTEMS CONFIGURED TO DYNAMICALLY UPDATE A UNIFORM DATA STATE BASED ON A UTILIZATION OF A PLUGIN ENGINE

(71) Applicant: Capital One Services, LLC, McLean, VA (US)

(72) Inventors: Shahryar Rashid, McLean, VA (US); Michelle Yu, McLean, VA (US); Sugavaneswaran Selvaraj, Frisco, TX (US); David Gillam, The Colony, TX (US); Kevin Wissink, McLean, VA (US)

(21) Appl. No.: 18/611,617

(22) Filed: Mar. 20, 2024

(51) Int. Cl. G06F 9/445

(52) U.S. Cl. CPC G06F 9/44526

(57) ABSTRACT

In some embodiments, the present disclosure provides an exemplary system and method that may include steps of identifying a plurality of data files associated with an external data source; utilizing an agnostic transaction module to configure each data file within the plurality of data files into a uniform data state; automatically modifying the uniform data state to a particular configuration type associated with a particular data destination source based on a configuration service; and dynamically updating a modified data state based on a utilization of a plugin management engine.

### FIELD OF TECHNOLOGY

The present disclosure generally relates to computer-based systems configured to dynamically update a uniform data state based on a utilization of a plugin engine.

### BACKGROUND OF TECHNOLOGY

Typically, a plugin is a software component that adds a specific feature to an existing computer program. A host application provides services that the plugin can use, including a way for plugins to register themselves with the host application and a protocol for the exchange of data with plugins. Typically, plugins depend on the services provided by the host application and do not typically work by themselves.

### SUMMARY OF DESCRIBED SUBJECT MATTER

In some embodiments, the present disclosure provides an exemplary technically improved computer-based method that includes at least the following steps: identifying, by a processor, a plurality of data files associated with an external data source; utilizing, by the processor, an agnostic transaction module to configure each data file within the plurality of data files into a uniform data state; automatically modifying, by the processor, the uniform data state to a particular configuration type associated with a particular data destination source based on a configuration service; and dynamically updating, by the processor, a modified data state based on a utilization of a plugin management engine.

In some embodiments, the present disclosure provides another technically improved computer-based method that includes at least the following steps: identifying a plurality of data files associated with an external data source; utilizing an agnostic transaction module to configure each data file within the plurality of data files into a uniform data state; automatically modifying the uniform data state to a particular configuration type associated with a particular data destination source based on a configuration service; utilizing a machine learning module and an artificial intelligence module to predict a behavior pattern associated with a particular user of a plurality of users based on the particular data destination source; automatically selecting a particular plugin of the plurality of plugins based on the behavior pattern of the particular user for subsequent use of the configuration service; and dynamically updating a modified data state associated with the particular plugin based on a utilization of a plugin management engine.

In some embodiments, the present disclosure provides an exemplary technically improved computer-based system that includes: a non-transient computer memory, storing software instructions; at least one processor of a first computing device associated with a user; where, when the processor executes the software instructions, the first computing device is programmed to: identify a plurality of data files associated with an external data source; utilize an agnostic transaction module to configure each data file within the plurality of data files into a uniform data state; automatically modify the uniform data state to a particular configuration type associated with a particular data destination source based on a configuration service; and dynamically update a modified data state based on a utilization of a plugin management engine.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for automatically modifying a uniform data state to a configuration type associated with a particular data destination source, in accordance with one or more embodiments of the present disclosure.

FIG. 2 is a flowchart diagram illustrating operational steps for dynamically updating a modified data state based on a utilization of a plugin management engine, in accordance with one or more embodiments of the present disclosure.

FIG. 3 depicts a flowchart diagram illustrating operational steps for applying a reusable service template based on a recommendation path associated with the plugin management engine, in accordance with one or more embodiments of the present disclosure.

FIG. 4 depicts a block diagram of exemplary computer-based system/platform in accordance with one or more embodiments of the present disclosure.

FIG. 5 depicts a block diagram of another exemplary computer-based system/platform in accordance with one or more embodiments of the present disclosure.

FIGS. 6 and 7 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

At least some embodiments of the present disclosure provide technological solution(s) to at least one technological computer-centered problem associated with allowing a single computing device to access a typical multi-resource platform. Typically, when the computing device attempts to access the typical multi-resource platform, an action of the computing device may cause a generation of duplicate code and additional efforts across the resources of the multi-resource platform. Moreover, each resource may require a separate configuration type to access their platform, which may lead to potential fraudulent attacks due a failure to efficiently complete a complex task and may also increase a runtime associated with a determination of an optimal path for the platform to connect particular resources with particular computing devices. In other instances, the technological computer-centered problem may arise due the computing device knowing the identity of the resource prior to accessing the platform, where this may cause the potential fraudulent attacks of a computing device based on the configuration type utilized by a particular resource. In one typical application, at least some embodiments of the present disclosure provide technological solution(s) to at least one technological computer-centered problem associated with allowing a broker to access a multi-lender platform. Typically, when a broker attempts to access a multi-lender platform, an action of the broker may cause a generation of duplicate code and additional efforts across the lenders of the multi-lender platform. Moreover, each lender may require a separate configuration type to access their platform, which may lead to potential fraudulent attacks due a failure to efficiently complete a complex task and may also increase a runtime associated with a determination of an optimal path for the platform to connect particular lenders with particular brokers. In other instances, the technological computer-centered problem may arise due a broker knowing the identity of the lender prior to accessing the platform, where this may cause the potential fraudulent attacks of a broker based on the configuration type utilized by a particular lender.

As detailed in at least some embodiments herein, at least one technological computer-centered solution addressing the technological computer-centered problem may be to utilize an agnostic transaction module to configure each data file within a plurality of data files into a uniform data state and automatically modify the uniform data state to configuration type associated with a particular data destination source based on the configuration service. In some embodiments, the present disclosure may identify a plurality of data files associated with an external data source. In some embodiments, the present disclosure may dynamically update a modified data state based on a utilization of a plugin management engine. In some embodiments, the present disclosure may utilize a machine learning module and an artificial intelligence module to predict behavior patterns associated with a plurality of particular brokers. In some embodiments, the present disclosure may automatically select a particular plugin based on a predicted behavior of a particular broker for subsequent use. In some embodiments, the present disclosure may utilize a graphical user interface within a computing device to display the dynamic updates to the modified data states.

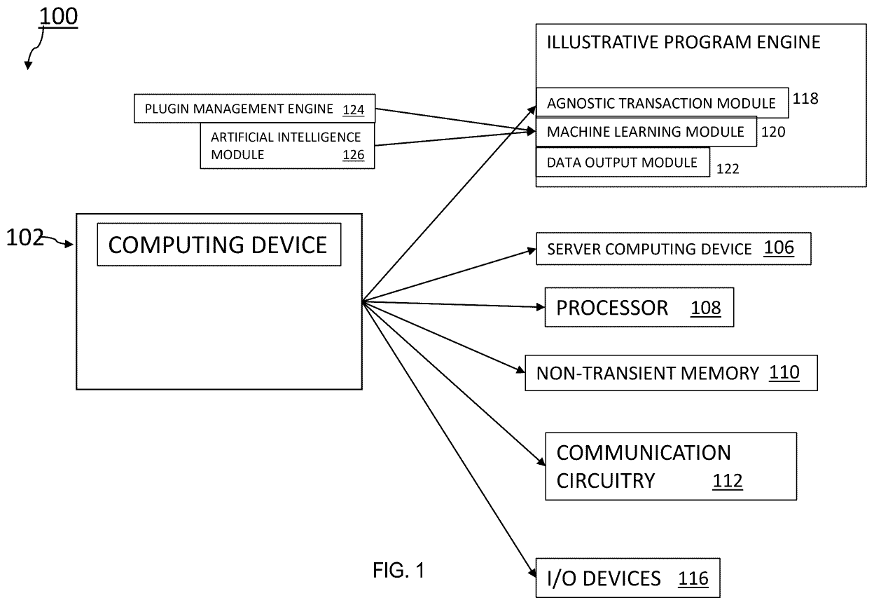

FIG. 1 depicts a block diagram of an exemplary computer-based system and platform for automatically modifying a uniform data state to a configuration type associated with a particular data destination source, in accordance with one or more embodiments of the present disclosure.

In some embodiments, an illustrative computing system 100 of the present disclosure may include at least one computing device 102 associated with at least one user and an illustrative program engine 104. In some embodiments, the illustrative program engine 104 may be stored on the computing device 102. In some embodiments, the illustrative program engine 104 may be executed stored on the computing device 102, which may include a or a server computing device 106, a processor 108, a non-transient computer memory 110, a communication circuitry 112 for communicating over a communication network 114 (not shown), and input and/or output (I/O) devices 116 such as a keyboard, mouse, a touchscreen, and/or a display, for example. In some embodiments, the computing device 102 may refer to at least one communicative computing device of a plurality of communicative computing devices. In certain embodiments, the server computing device 106 may be an external data source that is considered hardware. In some embodiments, the server computing device 106 may consist of a plurality of software engines to preform actions. In some embodiments, the computing device 102 may be considered the server computing device 106. For example, the computing device 102 is a particular piece of hardware configured to perform a plurality of actions.

In some embodiments, the illustrative program engine 104 may be configured to instruct the processor 108 to execute one or more software modules such as, without limitation, an exemplary agnostic transaction module 118, a machine learning module 120, and/or a data output module 122.

In some embodiments, an exemplary agnostic transaction module 118 of the present disclosure may utilize at least one trained machine learning module 120, described herein, to identify a plurality of data files associated with an external data source. In certain embodiments, the plurality of data files may refer to a plurality of pre-stored configuration files. The external data source may refer to a digital marketplace. For example, the external data source may refer to a digital multi-lender platform that allows a plurality of brokers to exchange and transfer data. In some embodiments, the exemplary agnostic transaction module 118 may configure each data file within the plurality of data files into a uniform data state. In certain embodiments, the exemplary agnostic transaction module 118 may include a plurality of predetermined capabilities associated with a particular user and a particular configuration service. In certain embodiments, the particular configuration service may refer to a configuration loader and a plugin management engine. A configuration loader may retrieve a plurality of rules associated with each configuration type and automatically load the plurality of rules associated with a particular configuration type associated with the data file into the program 104 of the computing device 102. The plugin management engine may refer to a rules engine that is capable of identifying a plurality of plugins that may assist the computing device 102 configure a data file; analyzing the plurality of plugins and the data files to compare relationships between each plugin and each data file type; ranking each plugin within the plurality of plugins based on these relationships; and selecting at least one plugin of the plurality of plugins that has a highest comparison value and ranked at higher priority than other plugins within the plurality of plugins. In some embodiments, the exemplary agnostic transaction module 118 may automatically modify the uniform data state to a particular configuration type associated with a particular data destination source based on the configuration service. In certain embodiments, the configuration type may refer to metadata associated with the uniform data state and a plurality of dependencies associated with the uniform data state. In some embodiments, the exemplary agnostic transaction module 118 may dynamically update a modified data state based on a utilization of a plugin management engine. 124. The plugin management engine 124 may include a plurality of plugins that assist in the configuration associated with a particular data designation. In some embodiments, the exemplary agnostic transaction module 118 may utilize a machine learning module 120 and an artificial intelligence module 126 to predict behavior patterns associated with particular brokers for subsequent use. The machine learning module 120 may analyze a plurality of previously collected actions associated with each particular broker over a predetermined period of time and output a result of the analysis as at least one prediction of a plurality of predictions based on the analysis of the plurality of the previously collection actions. The artificial intelligence module 126 may automatically rank the plurality of predictions and dynamically select the at least one prediction of the plurality of predictions based on a scenario score associated with each prediction. The prediction may refer to an estimation of a scenario based on the analysis of the collection of previous activities. The scenario score may be an aggregated score associated with a value of each parameter of a plurality of parameters associated with each prediction based on the analysis of the collection of previous actions. In some embodiments, the exemplary agnostic transaction module 118 may automatically select a particular plugin of the plurality of plugins based on a predicted behavior of a predicted behavior for subsequent use. In some embodiments, the exemplary agnostic transaction module 118 may utilize a graphical user interface within the computing device 102 to display a dynamic update to the modified data state.

In some embodiments, the present disclosure describes systems for utilizing the machine learning module 120 that may configure each data file within the plurality of data files into a uniform data state, where the machine learning module 120 may include a plurality of predetermined capabilities associated with a particular user and a particular configuration service. In certain embodiments, the configuration service may refer to a configuration loader and the plugin management engine 124 operating in unison. In some embodiments, the machine learning module 120 may automatically modify the uniform data state to a particular configuration type associated with a particular data destination source based on the configuration service. In certain embodiments, the particular configuration type may refer to metadata associated with the uniform data state and a plurality of dependencies associated with the uniform data state. In some embodiments, the machine learning module 120 may dynamically update the modified data state based on a utilization of the plugin management engine 124. In certain embodiments, the plugin management engine 124 may include a plurality of plugins that assist in the configuration associated with the particular data designation.

In some embodiments, the data output module 122 may output the plurality of data files associated with an external data source, where the data files may refer to a plurality of configuration files and the external data source may refer to a digital marketplace. In some embodiments, the data output module 122 may output a configuration of each data file within the plurality of data files into a uniform data state. In some embodiments, the data output module 122 may output a modification to the uniform data state to a particular configuration type associated with a particular data designation source based on the configuration service. In some embodiments, the data output module 122 may output a dynamic update to a modified state based on a utilization of the plugin management engine 124.

In some embodiments, the illustrative program engine 104 may identify a plurality of data files associated with an external data source. In certain embodiments, the plurality of data files may refer to a plurality of configuration files. In certain embodiments, the external data source may refer to a digital marketplace. In some embodiments, the illustrative program engine 104 may utilize the exemplary agnostic transaction module 118 to configure each data file within the plurality of data files into a uniform data state. In certain embodiments, the exemplary agnostic transaction module 118 may include a plurality of predetermined capabilities associated with a particular user and a particular configuration service. In certain embodiments, the particular configuration service may include to a particular configuration loader and the plugin management engine 124. In some embodiments, the illustrative program engine 104 may automatically modify the uniform data state to the particular configuration type associated with the particular data destination source based on the particular configuration service. In certain embodiments, the particular configuration type may refer to metadata associated with the uniform data state and a plurality of dependencies associated with the uniform data state. In some embodiments, the illustrative program engine 104 may dynamically update a modified data state based on a utilization of the plugin management engine 124, where the plugin management engine 124 may include a plurality of plugins that assist in the configuration associated with the particular data designation.

In some embodiments, the non-transient computer memory 110 may store the plurality of data files associated with the external data source. In some embodiments, the non-transient computer memory 110 may store a configuration for each data file within the plurality of data files into the uniform data state. In some embodiments, the non-transient computer memory 110 may store an automatic modification to the uniform data state into a particular configuration type associated with a particular data designation source based on the configuration service. In some embodiments, the non-transient computer memory 110 may store a dynamic update to the modified data state based on the utilization of the plugin management engine 124.

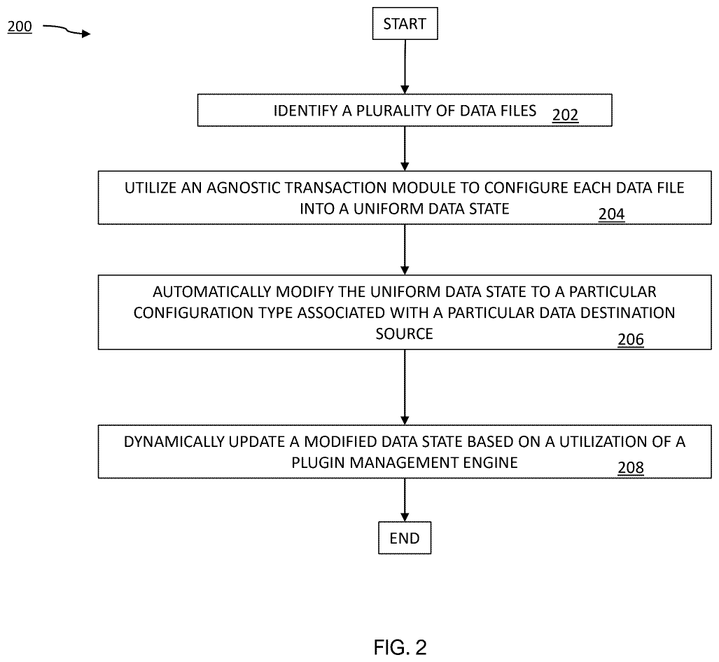

FIG. 2 is a flowchart 200 illustrating operational steps for dynamically updating a modified data state based on a utilization of a plugin management engine, in accordance with one or more embodiments of the present disclosure.

In step 202, the illustrative program engine 104 within the computing device 102 may identify a plurality of data files. In some embodiments, the illustrative program engine 104 may identify the plurality of data files associated with an external data source. In some embodiments, the plurality of data files may refer to a plurality of configuration data files, where the plurality of configuration data files may include each type of configuration data file associated with each type of external data source. In certain embodiments, the external data source may refer to a digital marketplace. For example, the illustrative program engine 104 may identify a plurality of configuration data type files associated with a lender-based digital platform. In some embodiments, the exemplary agnostic transaction module 118 may identify the plurality of data files associated with the external data source.

In step 204, the illustrative program engine 104 may configure each data file. In some embodiments, the illustrative program engine 104 may configure each data file within the plurality of data files. In some embodiments, the illustrative program engine 104 may utilize the exemplary agnostic transaction module 118 to configure each data file within the plurality of data files into a uniform data state. The uniform data state may refer to a normalized configuration data type consistent across the plurality of data files. For example, a normalized configuration data type may refer to a Boolean data type associated with a plurality of digital marketplaces, where each Boolean data type may refer to a particular digital marketplace of a particular lender. In some embodiments, the exemplary agnostic transaction module 118 may include a plurality of predetermined capabilities associated with a particular user and a particular configuration service. In certain embodiments, the configuration service associated with the exemplary agnostic transaction module 118 may refer to a particular configuration loader and the plugin management engine 124. The particular configuration loader may refer to a configuration loader that dynamically loads a particular configuration type associated with each data file within the computing device 102. The plugin management engine 124 may refer to a database of plugins that recommend a predicted path to a particular plugin based on the particular configuration type associated with the particular data file. In some embodiments, the exemplary agnostic transaction module 118 may configure each data file within the plurality of data files into the uniform data state.

In step 206, the illustrative program engine 104 may automatically modify the uniform data state. In some embodiments, the illustrative program engine 104 may automatically modify the uniform data state into a particular configuration type. In some embodiments, the illustrative program engine 104 may automatically modify the uniform data state into the particular configuration type associated with a particular data destination source. The particular data destination source may refer to a particular lender digital platform and a respective configuration type associated with the particular lender digital platform. In some embodiments, the illustrative program engine 104 may automatically modify the uniform data state into the particular configuration type associated with the particular data destination source based on the particular configuration service. In certain embodiments, the configuration type may refer to metadata associated with the uniform data state and a plurality of dependencies associated with the uniform data state. In some embodiments, the exemplary agnostic transaction module 118 may automatically modify the uniform data state into the particular configuration type associated with the particular data destination source based on the particular configuration service.

In step 208, the illustrative program engine 104 may dynamically update the modified data state. In some embodiments, the illustrative program engine 104 may dynamically update the modified data state based on a utilization of the plugin management engine 124. In some embodiments, the modified data state may refer to the normalized data state aggregated with at least one modification associated with the particular configuration type related to the particular data destination source. For example, the dynamic update to the modified data state may an alteration in configuration type to conform with a particular digital platform associated with a particular lender. In some embodiments, the exemplary agnostic transaction module 118 may dynamically update the modified data state based on a utilization of the plugin management engine 124.

In some embodiments, the illustrative program engine 104 may utilize the machine learning module 120 and an artificial intelligence module 126 to predict behavior patterns associated with a plurality of users. In certain embodiments, the predicted behavior patterns may refer to recommended paths to particular plugins within the plurality of plugins that correctly correspond with previously visited destination data sources. In certain embodiments, the recommended path to plugins may refer to a recorded collection of a plurality of previous paths taken via the plugin management engine 124 to particular plugins associated with particular data destination sources (i.e., digital marketplace associated with particular lenders). In certain embodiments, the plurality of users may refer to a plurality of brokers attempting to interact with the digital marketplace. In some embodiments, the illustrative program engine 104 may automatically select a particular plugin of the plurality of plugins based on a predicted behavior of a particular user for subsequent use, where the particular user may refer to a particular broker. In some embodiments, the illustrative program engine 104 may utilize a graphical user interface within the computing device 102 to display at least one dynamic update to the modified data state on the computing device 102.

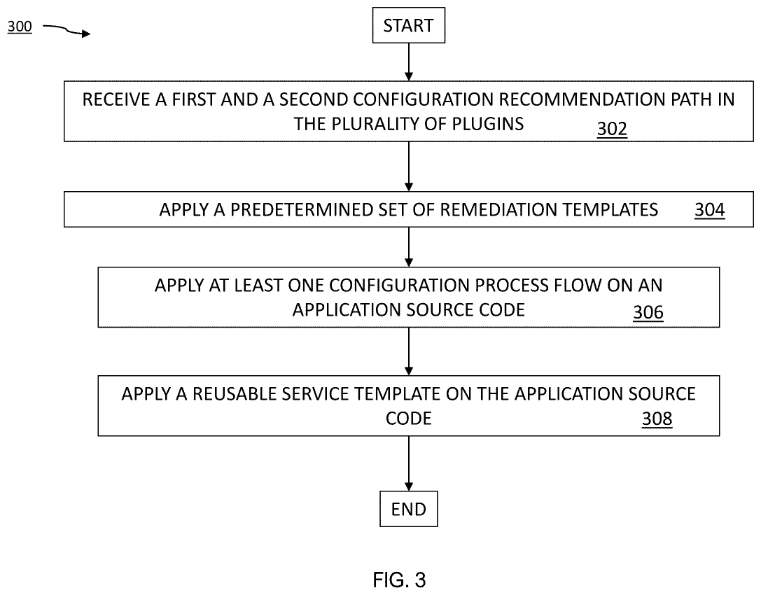

FIG. 3 depicts a flowchart diagram 300 illustrating operational steps for updating a database based on an authorized user and additional information, in accordance with one or more embodiments of the present disclosure.

In step 302, the illustrative program engine 104 may receive a configuration recommendation path. In some embodiments, the illustrative program engine 104 may receive a first and a second configuration recommendation path. In certain embodiments, these recommendation paths may refer to paths to particular plugins associated with previously interacted destination data sources (i.e., particular lender digital marketplace). In some embodiments, the exemplary agnostic transaction module 118 may receive the first and the second configuration recommendation path.

In step 304, the illustrative program engine 104 may apply a set of remediation templates. In some embodiments, the illustrative program engine 104 may apply the set of remediation template based on the first and the second configuration recommendation paths. In certain embodiments, the set of remediation steps may include a plurality of pre-defined parameterized actions. In some embodiments, the exemplary agnostic transaction module 118 may apply the set of remediation template based on the first and the second configuration recommendation paths.

In step 306, the illustrative program engine 104 may apply a pre-determined configuration process flow. In some embodiments, the illustrative program engine 104 may apply the pre-determined configuration process flow on an application source code associated with the particular data destination source. In some embodiments, the illustrative program engine 104 may apply the pre-determined configuration process flow on the application source code based on the first and the second configuration recommendation paths. In certain embodiment, the pre-defined configuration process flow may refer to a pre-processing stage involving analyzing the application source code, a target configuration framework, and a determination of a plurality of dependencies. In certain embodiments, the pre-defined configuration process flow may execute a plurality of operations in a plurality of phases. For example, the pre-defined configuration process flow may execute the plurality of operations in a detect phase, an analyze phase, and a transform phase. The detect phase may refer to a determination whether the pre-defined configuration process flow is applicable to the application source code associated with the particular data destination source. In some embodiments, the exemplary agnostic transaction module 118 may apply the pre-determined configuration process flow on an application source code associated with the particular data destination source.

In step 308, the illustrative program engine 104 may apply a reusable service template on the application source code. In some embodiments, the illustrative program engine 104 may apply the reusable service template on the application source code based on the first and the second configuration recommendation paths. In certain embodiments, the reusable service template may apply a plurality of repeatable code modifications that may be required for integration and deployment of the particular configuration type associated with the particular data destination source. In some embodiments, the exemplary agnostic transaction module 118 may apply the reusable service template on the application source code based on the first and the second configuration recommendation paths.

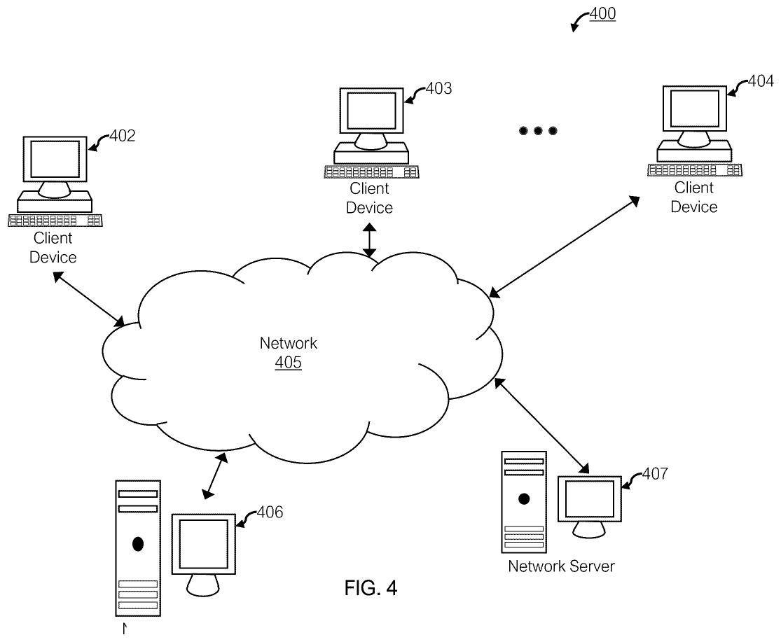

FIG. 4 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to automatically modify the uniform data state to a particular configuration type associated with a particular data destination source based on a configuration service; utilize a machine learning module 120 and an artificial intelligence 126 module to predict a behavior pattern associated with a particular user of a plurality of users based on the particular data destination source; automatically select a particular plugin of the plurality of plugins based on the behavior pattern of the particular user for subsequent use of the configuration service; and dynamically update a modified data state associated with the particular plugin based on a utilization of a plugin management engine 124, as detailed herein. In some embodiments, the exemplary computer-based system/platform 400 may be based on a scalable computer and/or network architecture that incorporates varies strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 400 may be configured to manage the exemplary agnostic transaction module 118 of the present disclosure, utilizing at least one machine-learning model described herein.

In some embodiments, referring to FIG. 4, members 402-404 (e.g., clients) of the exemplary computer-based system/platform 400 may include virtually any computing device capable of automatically generate a provision utilizing the virtual card number to perform a particular action associated with device of the particular user via a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may launch one or more applications, such as Internet browsers, mobile applications, voice calls, video games, videoconferencing, and email, among others. In some embodiments, one or more member devices within member devices 402-404 may be configured to receive and to send web pages, and the like. In some embodiments, the exemplary agnostic transaction module 118 of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to automatically modify the uniform data state to a particular configuration type associated with a particular data destination source based on a configuration service; utilize a machine learning module 120 and an artificial intelligence 126 module to predict a behavior pattern associated with a particular user of a plurality of users based on the particular data destination source; automatically select a particular plugin of the plurality of plugins based on the behavior pattern of the particular user for subsequent use of the configuration service; and dynamically update a modified data state associated with the particular plugin based on a utilization of a plugin management engine 124.

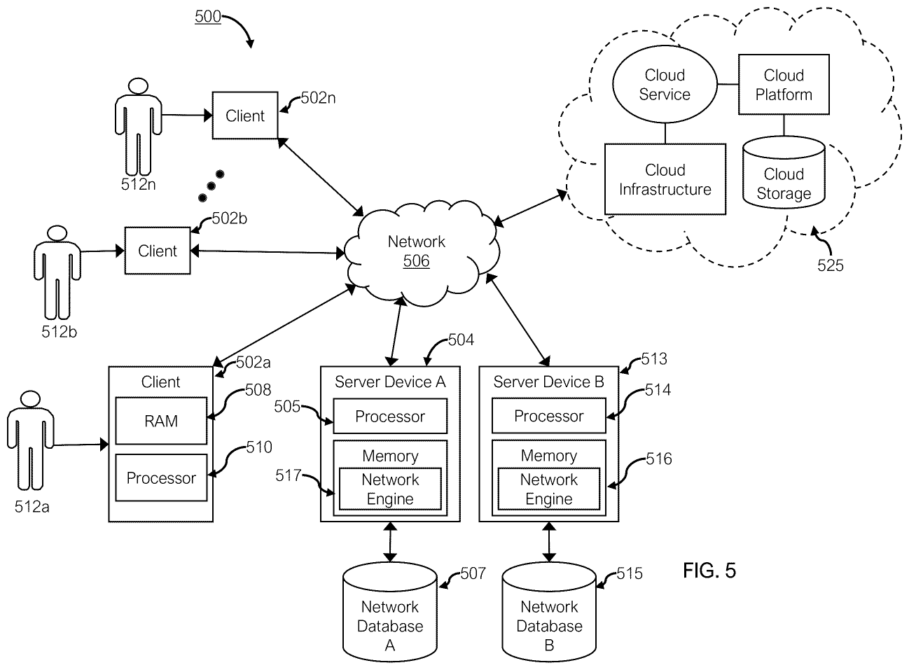

FIG. 5 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™ Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 5, exemplary server devices 504 and 513 may be also coupled to the network 506. Exemplary server device 504 may include a processor 505 coupled to a memory that stores a network engine 517. Exemplary server device 513 may include a processor 514 coupled to a memory 516 that stores a network engine. In some embodiments, one or more member computing devices 502a through 502n may be mobile clients. As shown in FIG. 5, the network 506 may be coupled to a cloud computing/architecture(s) 525. The cloud computing/architecture(s) 525 may include a cloud service coupled to a cloud infrastructure and a cloud platform, where the cloud platform may be coupled to a cloud storage.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

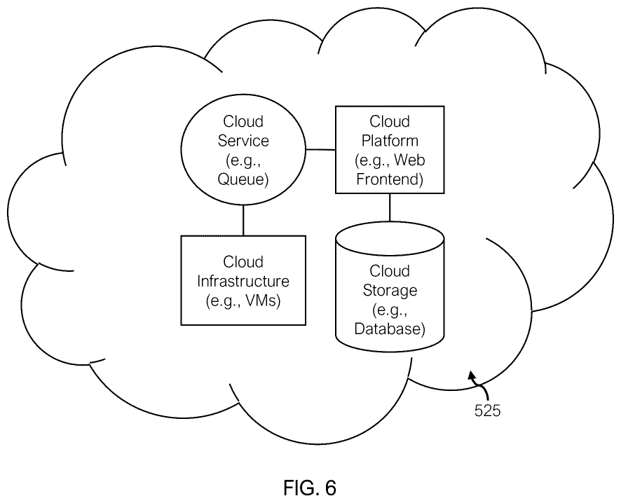

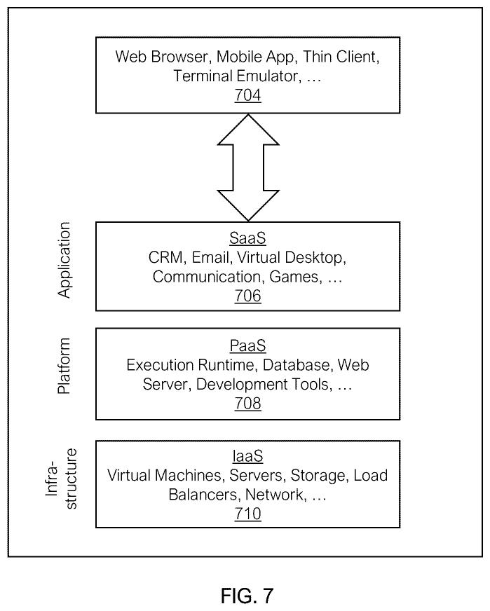

FIG. 6 and FIG. 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 6 illustrates an expanded view of the cloud computing/architecture(s) 525 found in FIG. 5. FIG. 7. illustrates the exemplary inventive computer-based components of the present disclosure may be specifically configured to operate in the cloud computing/architecture 525 as a source database 704, where the source database 704 may be a web browser. a mobile application, a thin client, and a terminal emulator. In FIG. 7, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS) 710, platform as a service (PaaS) 708, and/or software as a service (SaaS) 706.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; TM (20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

The aforementioned examples are, of course, illustrative and not restrictive. At least some aspects of the present disclosure will now be described with reference to the following numbered clauses.

Clause 1. A computer-implemented method may include: identifying a plurality of data files associated with an external data source; utilizing an agnostic transaction module to configure each data file within the plurality of data files into a uniform data state, where the agnostic transaction module includes a plurality of predetermined capabilities associated with a particular user and a configuration service; utilizing a machine learning module and an artificial intelligence module to predict behavior patterns associated with a plurality of users; automatically modifying, by the processor, the uniform data state to a particular configuration type associated with a particular data destination source based on a configuration service, where the configuration service associated with the agnostic transaction module includes a configuration loader and a plugin management engine; and dynamically updating, by the processor, a modified data state based on a utilization of a plugin management engine, where an update to the modified data state occurs at predetermined timed intervals.

Clause 2. The method according to clause 1, where the plurality of data files include a plurality of configuration files.

Clause 3. The method according to clause 1 or 2, where the external data source includes a digital marketplace.

Clause 4. The method according to clause 1, 2 or 3, where the machine learning module comprises performing an analysis on the uniform data state.

Clause 5. The method according to clause 1, 2, 3 or 4, where the artificial intelligence module includes: automatically ranking a plurality of scenarios associated with the analysis of the uniform data state, and dynamically selecting at least one scenario of the plurality of scenario based on an aggregated scenario score associated with the analysis of the uniform data state.

Clause 6. The method according to clause 1, 2, 3, 4 or 5, where the particular configuration type includes metadata associated with the uniform data state and dependencies associated with the uniform data state.

Clause 7. The method according to clause 1, 2, 3, 4, 5 or 6, where the plugin management engines includes a plurality of plugins that assist in the configuration associated with the particular data destination source.

Clause 8. The method according to clause 1, 2, 3, 4, 5, 6 or 7, further including receiving a first and a second configuration recommendation path in the plurality of plugins; applying a predetermined set of remediation templates based on the first and the second configuration recommendation paths in the plurality of plugins; applying at least one configuration process flow on an application source code associated with the particular data destination source based on the configuration service; and applying a reusable service template on the application source code based on the first and the second configuration recommendation paths in the plurality of plugins.

Clause 9. The method according to clause 1, 2, 3, 4, 5, 6, 7 or 8, where the reusable service template includes a plurality of repeatable code modifications required for integration and deployment of the particular configuration type associated with the particular data destination source.

Clause 10. The method according to clause 1, 2, 3, 4, 5, 6, 7, 8 or 9, further including utilizing a machine learning module and an artificial intelligence module to predict behavior patterns associated with a plurality of users.

Clause 11. The method according to clause 1, 2, 3, 4, 5, 6, 7, 8, 9 or 10, where the predicted behavior patterns include a plurality of recommended paths to a particular set of plugins within the plurality of plugins that correctly correspond with at least one data destination source.

Clause 12. The method according to clause 1, 2, 3, 4, 5, 6, 7, 8, 9, 10 or 11, where the recommended path to the particular set of plugins includes a recorded collection of a plurality of previous paths taken via the plugin management engine to at least one particular plugin associated with the particular data destination source.

Clause 13. The method according to clause 1, 2, 3, 4, 5, 6, 7, 8, 9, 10, 11 or 12, further including comprising automatically selecting a particular plugin of the plurality of plugins based on a predicted behavior of a particular user for subsequent use.

Clause 14. The method according to clause 1, 2, 3, 4, 5, 6, 7, 8, 9, 10, 11, 12 or 13, where the particular user includes to a particular broker seeking to interact with a particular lender.

Clause 15. The method according to clause 1, 2, 3, 4, 5, 6, 7, 8, 9, 10, 11, 12, 13 or 14, further including utilizing a graphical user interface within a computing device to display at least one dynamic update to the modified data state based on the configuration service.

Clause 16. A computer-implemented method may include: identifying a plurality of data files associated with an external data source; utilizing an agnostic transaction module to configure each data file within the plurality of data files into a uniform data state; automatically modifying the uniform data state to a particular configuration type associated with a particular data destination source based on a configuration service; utilizing a machine learning module and an artificial intelligence module to predict a behavior pattern associated with a particular user of a plurality of users based on the particular data destination source; automatically selecting a particular plugin of the plurality of plugins based on the behavior pattern of the particular user for subsequent use of the configuration service; and dynamically updating a modified data state associated with the particular plugin based on a utilization of a plugin management engine.

Clause 17. The method according to clause 16, further including receiving a first and a second configuration recommendation path in the plurality of plugins; applying a predetermined set of remediation templates based on the first and the second configuration recommendation paths in the plurality of plugins; applying at least one configuration process flow on an application source code associated with the particular data destination source based on the configuration service; and applying a reusable service template on the application source code based on the first and the second configuration recommendation paths in the plurality of plugins.

Clause 18. The method according to clause 16 or 17, where the reusable service template includes a plurality of repeatable code modifications required for integration and deployment of the particular configuration type associated with the particular data destination source.

Clause 19. The method according to clause 16, 17 or 18, further including utilizing a graphical user interface within the computing device to display at least one dynamic update to the modified data state based on the configuration service.

Clause 20. A system may include: a non-transient computer memory, storing software instructions; at least one processor of a computing device associated with a user; where, when the processor executes the software instructions, the computing device is programmed to: identify a plurality of data files associated with an external data source; utilize an agnostic transaction module to configure each data file within the plurality of data files into a uniform data state; automatically modify the uniform data state to a particular configuration type associated with a particular data destination source based on a configuration service; and dynamically update a modified data state based on a utilization of a plugin management engine.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A computer-implemented method comprising:
identifying, by a processor, a plurality of data files associated with an external data source;
utilizing, by the processor, an agnostic transaction module to configure each data file within the plurality of data files into a uniform data state,
wherein the agnostic transaction module comprises a plurality of predetermined capabilities associated with a particular user and a configuration service;
utilizing a machine learning module and an artificial intelligence module to predict behavior patterns associated with a plurality of users;
automatically modifying, by the processor, the uniform data state to a particular configuration type associated with a particular data destination source based on a configuration service,
wherein the configuration service associated with the agnostic transaction module comprises a configuration loader and a plugin management engine; and
dynamically updating, by the processor, a modified data state based on a utilization of a plugin management engine,
wherein an update to the modified data state occurs at predetermined timed intervals.

2. The method of claim 1, wherein the plurality of data files comprise a plurality of configuration files.

3. The method of claim 1, wherein the external data source comprises a digital marketplace.

4. The method of claim 1, wherein the machine learning module comprises performing an analysis on the uniform data state.

5. The method of claim 4, wherein the artificial intelligence module comprises:
automatically ranking a plurality of scenarios associated with the analysis of the uniform data state, and
dynamically selecting at least one scenario of the plurality of scenario based on an aggregated scenario score associated with the analysis of the uniform data state.

6. The method of claim 1, wherein the particular configuration type comprises metadata associated with the uniform data state and dependencies associated with the uniform data state.

7. The method of claim 1, wherein the plugin management engines comprises a plurality of plugins that assist in the configuration associated with the particular data destination source.

8. The method of claim 1, further comprising:
receiving a first and a second configuration recommendation path in the plurality of plugins;
applying a predetermined set of remediation templates based on the first and the second configuration recommendation paths in the plurality of plugins;
applying at least one configuration process flow on an application source code associated with the particular data destination source based on the configuration service; and
applying a reusable service template on the application source code based on the first and the second configuration recommendation paths in the plurality of plugins.

9. The method of claim 8, wherein the reusable service template comprises a plurality of repeatable code modifications required for integration and deployment of the particular configuration type associated with the particular data destination source.

10. The method of claim 1, further comprising utilizing a machine learning module and an artificial intelligence module to predict behavior patterns associated with a plurality of users.

11. The method of claim 10, wherein the predicted behavior patterns comprise a plurality of recommended paths to a particular set of plugins within the plurality of plugins that correctly correspond with at least one data destination source.

12. The method of claim 11, wherein the recommended path to the particular set of plugins comprises a recorded collection of a plurality of previous paths taken via the plugin management engine to at least one particular plugin associated with the particular data destination source.

13. The method of claim 1, further comprising automatically selecting a particular plugin of the plurality of plugins based on a predicted behavior of a particular user for subsequent use.

14. The method of claim 13, wherein the particular user comprises a particular broker seeking to interact with a particular lender.

15. The method of claim 1, further comprising utilizing a graphical user interface within a computing device to display at least one dynamic update to the modified data state based on the configuration service.

16. A computer-implemented method comprising:
identifying, by a processor, a plurality of data files associated with an external data source;
utilizing, by the processor, an agnostic transaction module to configure each data file within the plurality of data files into a uniform data state;
automatically modifying, by the processor, the uniform data state to a particular configuration type associated with a particular data destination source based on a configuration service;
utilizing, by the processor, a machine learning module and an artificial intelligence module to predict a behavior pattern associated with a particular user of a plurality of users based on the particular data destination source;
automatically selecting, by the processor, a particular plugin of the plurality of plugins based on the behavior pattern of the particular user for subsequent use of the configuration service; and
dynamically updating, by the processor, a modified data state associated with the particular plugin based on a utilization of a plugin management engine.

17. The method of claim 16, further comprising:
receiving a first and a second configuration recommendation path in the plurality of plugins;
applying a predetermined set of remediation templates based on the first and the second configuration recommendation paths in the plurality of plugins;
applying at least one configuration process flow on an application source code associated with the particular data destination source based on the configuration service;
applying a reusable service template on the application source code based on the first and the second configuration recommendation paths in the plurality of plugins.

18. The method of claim 17, wherein the reusable service template comprises a plurality of repeatable code modifications required for integration and deployment of the particular configuration type associated with the particular data destination source.

19. The method of claim 16, further comprising utilizing a graphical user interface within a computing device to display at least one dynamic update to the modified data state based on the configuration service.

20. A system comprises:
a non-transient computer memory, storing software instructions;
at least one processor of a first computing device associated with a user;
wherein, when the processor executes the software instructions, the first computing device is programmed to:
identify a plurality of data files associated with an external data source;
utilize an agnostic transaction module to configure each data file within the plurality of data files into a uniform data state;
automatically modify the uniform data state to a particular configuration type associated with a particular data destination source based on a configuration service; and
dynamically update a modified data state based on a utilization of a plugin management engine.
